(19) United States
(12) Patent Application Publication
(10) Pub. No.: US 2008/0144893 A1
(43) Pub. Date: Jun. 19, 2008

(54) APPARATUS AND METHOD FOR SELECTING KEY FRAMES OF CLEAR FACES THROUGH A SEQUENCE OF IMAGES

(75) Inventors: Chun Biao GUO, Singapore (SG); Ruowei ZHOU, Singapore (SG); Qi TIAN, Singapore (SG)

Correspondence Address: GREENBLUM & BERNSTEIN, P.L.C., 1950 ROLAND CLARKE PLACE, RESTON, VA, 20191, US

(73) Assignees: VISLOG TECHNOLOGY PTE LTD, Singapore (SG); AGENCY FOR SCIENCE, TECHNOLOGY, AND RESEARCH, Singapore (SG)

(21) Appl. No.: 11/950,842

(22) Filed: Dec. 5, 2007

Related U.S. Application Data
(63) Continuation of application No. 10/488,929, filed on Mar. 12, 2004, now abandoned.

(51) Int. Cl. G06K 9/00

(52) U.S. Cl. 382/118

(57) ABSTRACT

A system for determining a key frame of an image sequence wherein the key frame includes the clearest image of the face of a person from the image sequence, the system included an image input means for receiving the image sequence of the person and a processing means for identifying the face of the person in each frame of the image sequence and then determining which frame is the clearest image of the person's face.

### FIELD OF THE INVENTION

The present invention generally relates to digital video imaging systems. More particularly, the present invention relates to a method and apparatus which uses real-time image processing, video processing, video image analysis, video indexing and pattern recognition techniques to interpret and use video information.

### BACKGROUND OF THE INVENTION

With the growth and popularity of multimedia computing technologies, users are able to store greater amounts of information and retrieve data more quickly than ever before. Advances in data compression, storage, and telecommunications have enabled video to become an important data type for the future. However, it is not enough to simply store and play back complete video data as in commercial video-on-demand services. Given so much video collections, how we effectively organise, retrieve and use information from these sources is what this present invention is addressing.

Nowadays, with the development of video server technologies, calling up video clips stored on a video server is as simple as calling up word documents on a word processor, or doing a term search on an Internet search engine with a browser. However, unlike a word document, which may be indexed and accurately retrieved by key words, the time-dependent nature of video makes it very difficult to manage. Much of the vast quantity of video containing valuable information remains unindexed. This is because whereas the textual information may be readily parsed into discrete words, that can each be compared with predefined key words on a character-by-character basis; video information is far too rich and complex to be similarly parsed. Some existing video indexing systems require operators to view the entire video packages and to assign index means (text, image, or voice) manually to each of its scenes. Obviously, this approach is not feasible considering the abundance of unindexed videos and the lack of sufficient manpower and time. As a result, many automatic and semi-automatic methods were developed to extract information that describes contents of the recorded video material. These methods can be divided into three categories.

The first category extracts text information from audio-video contents and uses them as indexes. This technique will look at the textual representation derived from annotations, generated transcript, accompanying notes or from the closed captioning that might be available on broadcast material. Examples include the project conducted by Huiping Li and David Doermann of the laboratory of Language and Media Processing at the University of Maryland. In their project, time-varying text information is extracted and tracked in digital video for indexing and retrieval. The product “Video Gateway” developed by Pictron is also able to extract closed captions from digital video as text indexes.

The second category uses image/video analysis techniques and extracts key frames when appropriate. Methods of this category are used in two ways. In the first way, scene breaks are identified and static frames are selected as representatives of a scene. Examples include: U.S. Pat. No. 5,635,982, U.S. Pat. No. 6,137,544, U.S. Pat. No. 5,767,922, “Automatic Video Indexing and Full-Video Search for Object Appearances” (A. Nagasaka & Y. Tanaka, Proc. 2nd Working Conf. on Visual Database Systems, Budapest, 1991, pp. 119-133), and “Video Handling Based on Structured Information for Hypermedia Systems” (Y. Tonomura, Proc. Int'l Conf. on Multimedia Information Systems, Singapore, 1991, pp. 333-344). In the second way, specific images are identified as key frames according to some predefined criteria. The criteria may include pre-stored reference database, key features, or priori models. One example is the work performed by Gong et al. (Y. Gong et al. Automatic Parsing of TV Soccer Programs, The 2nd ACM International Conference on Multimedia Computing, pp. 167-174, May 1995).

The last category analyses speeches in video data and uses the recognized speeches as indexes. U.S. Pat. No. 5,828,809 describes a method and apparatus to automatically index the locations of specified events on a video tape. In this patent, a speech detection algorithm locates specific words in the audio portion data of the video tape. Locations where the specific words are found are passed to the video analysis algorithm for further processing.

The present invention falls into the second category of video indexing techniques. More specifically, it belongs to the second approach of the second category. That is, the present invention is related to identifying specific images as key frames according to some predefined criteria. By observing the prior art, it can be found that most of the existing key frame extraction methods are based on detecting camera motions, scene changes, abrupt object motions, or some obvious features. Although relatively new, key frame extraction and video indexing have attained a level of sophistication adequate to the most challenging of today's media environments. Media, broadcast, and entertainment companies have used them to streamline production processes, automate archive management, enable online commerce, and re-express existing material. However, not all companies that create or use video information are benefited from the boom of video indexing techniques. Most existing video indexing techniques focus on media type of video content: film, TV, advertising, computer game, etc.

For many non-media video information, which normally consists of real-life events, existing video indexing techniques (including key frame extraction) seem inefficient or unsuitable. Unfortunately, such kind of non-media video data occupies a considerable portion of the video information market and should not be neglected by any means. An intruder investigation process typifies the problem. A security officer is requested to screen the recorded digital surveillance video to find who is the intruder. The officer then spends hours sitting before his desktop, selecting one-by-one the recorded digital video files, reviewing all the selected files (although most of them are nonsense), and playing the relevant video file forward and backward to locate and select the specific frames which contain clear pictures of the intruder. Such a process is time-consuming, inefficient and expensive. The implication is clear. With video information becoming more valuable and the market becoming broader, users' expectations rise. They want means to intuitively search the video, find the precise segments or frames they need, re-express, compile, and publish them with unprecedented speed and facility. Existing key frame extraction and video indexing methods may provide the users with rich information regarding the camera and object motions. However, for applications like video surveillance, the users are more interested in the contents (who) than how the camera was used during the recording. If a content-based video indexing system can be developed to further analyse the video content and select the key frames with higher content importance, it will be of great use for the users.

Other attempts at face detection include U.S. Pat. No. 5,835,616 which discloses a two step process for automatically finding a human face in an electronically digitized image, and for confirming the existence of the face by examining facial features. The first step of detecting the human face is accomplished in stages that include enhancing the digital image with a blurring filter and edge enhancer in order to better set forth the unique facial features. The existence of the human face is confirmed by finding various facial features within the digital image. Ratios of the distances between these found facial features can then be compared to previously stored reference ratios for recognition. However, this patent merely locates a face within a single frame of an image. That is, given a frame, the system is able to determine the presence of a face provided the various facial features can be seen.

WO 9803966 discloses a method and apparatus for identifying, or verifying, the identity of objects such as faces. The system identifies various objects within the image such as the eyes and ears. The attributes of these objects may be compared in order to verify the authenticity of an identity of a person. However, again, it is required for the system to be presented with a frame of an image showing the full facial features.

U.S. Pat. No. 6,188,777 discloses a system to robustly track a target such as a person. Three primary modules are used to track a user's head, including depth estimation, colour segmentation and patent classification. However, this patent is more concerned with tracking a person and detecting the face of the person.

U.S. Pat. No. 6,184,926 provides for the detection of human heads, faces and eyes in an uncontrolled environment. This system did consider different head poses and was able to extract faces when presented with a frontal pose from the person.

U.S. Pat. No. 6,148,092 is directed towards a system for detecting skin tone regions within an image. This system simply attempts to identify or detect a human face in an image using colour information such as skin tone.

U.S. Pat. No. 6,108,437 describes a face recognition system, which first detects the presence of a face and then identifies the face.

Many methods and apparatus have been proposed for video indexing. However, they normally deal with scene transitions, camera movements and object motions. In some video applications such as video surveillance, where the content (who, what, where) is of great interest, existing video indexing techniques seem ineffective. If a content-based video indexing system can be developed to further analyze the video content and select the key frames with higher content importance, it will be of great use for the users.

Whilst the above systems provide, in varying aspect, for the detection of the face of a person within a frame of a video image and, in some cases, the identification of that face, in most instances a single frame of image is considered and analysed. These techniques, whilst possibly addressing some surveillance concerns, do not address all surveillance concerns. For example, where a record of a person's face is desired during the making of a transaction, such as at an ATM system, it would be preferable for the system to be able to select the clearest image of the face of the person from a video sequence. Such a system would obviously need to consider a number of frames, as opposed to a single frame.

### OBJECT OF THE INVENTION

It is therefore an objective of the present invention to provide a content-based video indexing system which can automatically detect the presence of human faces in each image frame of a video sequence, analyze the detected human faces and identify the frames with the clear faces as the key frames for the video sequence.

It is another objective of the present invention to provide a content-based video indexing system which has reliable operation in real life applications and is robust enough to function properly under various lighting conditions, background environments, and face poses.

A further objective of the present invention is to provide a content-based video indexing system which can rapidly identify face regions in the frames of video sequences, regardless to the skin color, hair color or other color related variables.

### SUMMARY OF THE INVENTION

With the above objects in mind, the present invention provides in one aspect a system for determining a key frame of an image sequence wherein said key frame includes a clearest image of the face of a person from said image sequence, said system including:

an image input means for receiving the image sequence of the person; and

a processing means for identifying the face of the person in each frame of the image sequence and then determining which frame is the clearest image of the person's face.

Ideally the processing means will compare each frame by analysing the pixels to identify a possible region for the persons face, scanning the region to find the most likely position of the face, and analysing the face to determine a clearest value The processing means may then compare the clearest value of each frame to determine the clearest frame.

The system may further include a storage means to enable the key frames to be stored with or without the accompanying video. Ideally compressed video would be included together with other data such as the date and time.

The system may advantageously by employed in an ATM surveillance system so as to record details of each transaction, together with the key frame and any other relevant data. The ATM surveillance system may be triggered by detection of motion approximate the ATM machine, or alternatively by a user commencing a transaction.

### BRIEF DESCRIPTION OF THE DRAWINGS

Further advantages of the invention will become apparent by reference to the detailed description of preferred embodiments when considered in conjunction with the following drawings wherein:

FIG. 1 shows the operational diagram of a conventional ATM surveillance system

FIG. 2 shows an operational diagram of a preferred embodiment (intelligent remote ATM surveillance system) of the present invention

FIG. 3 shows a block diagram of the preferred embodiment of FIG. 2

FIG. 4 shows a block diagram of the intelligent data indexing & archiving of the preferred embodiment as shown in FIG. 3

FIG. 5 shows the data flow of the intelligent data indexing & archiving of the preferred embodiment as shown in FIG. 3

FIG. 6 shows an operational diagram of the event detection of the intelligent data indexing & archiving in FIG. 4

FIG. 7 shows an operational diagram of the key frame extraction of the intelligent data indexing & archiving in FIG. 4

FIG. 8 shows a block diagram of the key frame extraction of the intelligent data indexing & archiving in FIG. 4

FIG. 9 shows a the block diagram of the two-step remote data retrieval of the preferred embodiment in FIG. 2

Corresponding reference characters indicate corresponding parts throughout the drawings.

### DESCRIPTION OF THE PREFERRED EMBODIMENT

The preferred embodiment of the present invention will be discussed herein after in detail with reference to the accompanying drawings. Descriptions of specific scenarios are provided only as examples. Consequently, the present invention is not intended to be limited to the embodiment shown but is to be accorded the widest scope consistent with the principles and features disclosed herein.

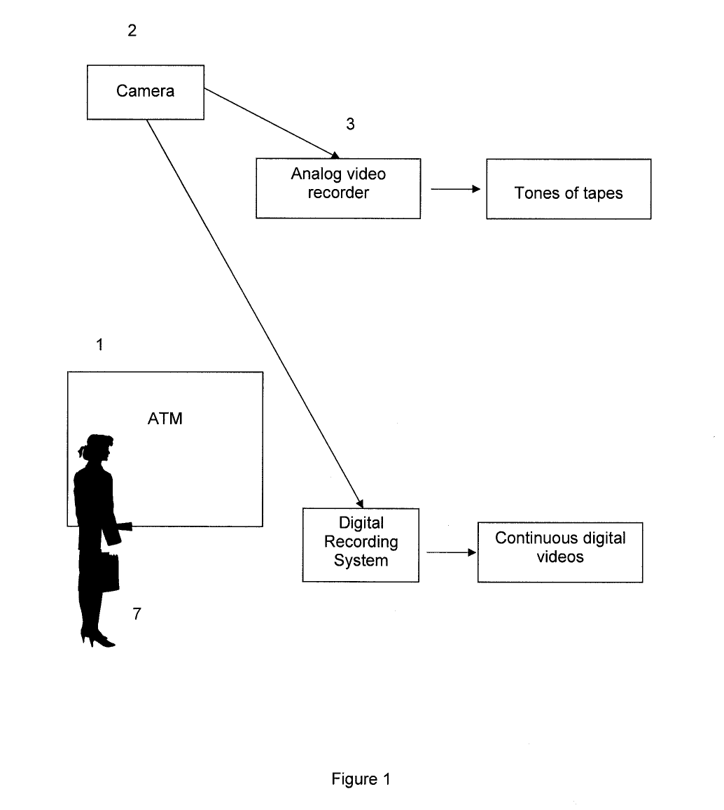

Referring to the drawings, a conventional ATM surveillance system is shown in FIG. 1. Normally, for an ATM machine 1 installation, there is at least one CCTV camera 2 installed nearby to monitor the transactions. The purpose of this camera 2 is to deter unlawful transactions and vandalism. In the event that a dispute arises, the video captured by the camera 2 will be used in court. To record the video, two types of recording equipment are used in the conventional ATM surveillance systems, namely an analog VCR recorder 3 and digital video recorders. However, for systems using VCR recorder, each VCR tape can store information up to a maximum of four hours only. This will require the bank to employ sufficient technical staff to go around the ATM machines to collect and change the VCR tapes. The process is time consuming and expensive. In addition, if there is any police request for information, it can only be provided after a few days of hectic, sequential search activities by sending the technical staff to collect the disputed tape, view the tape for the required segment, make a copy of it and give it to the police. Valuable time and money is wasted on such activities. As for ATM surveillance systems using a digital video recorder, the recording time can be much longer than VCR recorders. Moreover, such systems normally have remote retrieval capabilities. Bank users can send the data retrieval request to the remote system and get the data back through communication channels.

However, digital systems record video in an unselective and continuous way. To improve the performance, some may use extra sensors or simple motion detection means to help identify useful video segments. However, such methods are quite elementary in nature and the recorded video usually has no close correspondence to the user interested events. In addition, the size of digital video clips (10 MByte for 1 minute VCD quality video) is generally very large when considering the limited bandwidths of communication channels. It will cost a user more than one minute to retrieve a one-minute video clip from the remote site through an ISDN 2B line. If the video clip is not the desired one, the user has to spend a longer time in finding and retrieving the correct one.

In ATM surveillance applications, the ultimate goal is to identify the people in the video clip. The user has to go through the whole video clip, compare every frame, find the frame with the clearest face, save the identified frame into a separate file and send it to the relevant authorities. In normal ATM operations, a user transaction usually takes one to two minutes. For a one-minute transaction, the total number of frames contained in the video clip will be 1500 (frame rate 25 f/s). Obviously, the process is time-consuming, ineffective, and expensive.

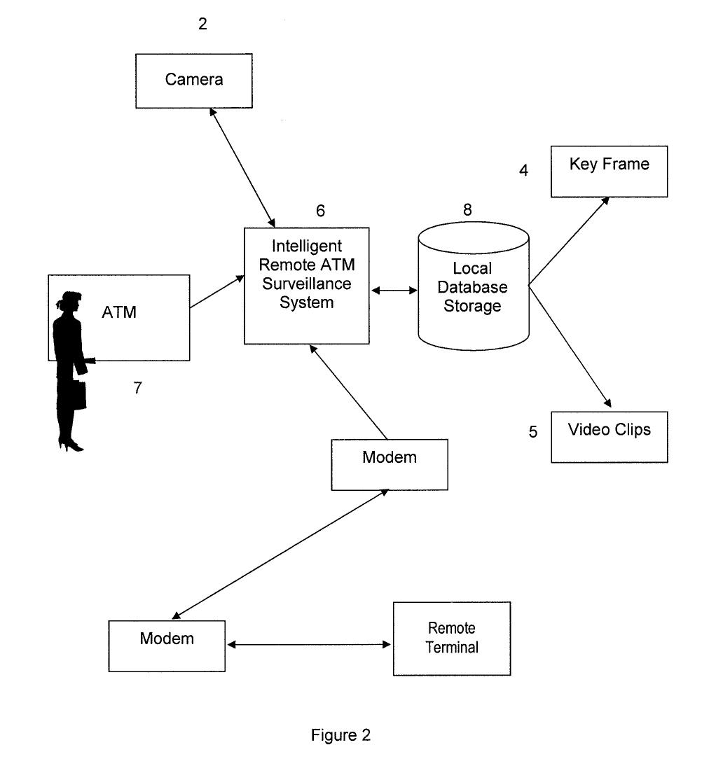

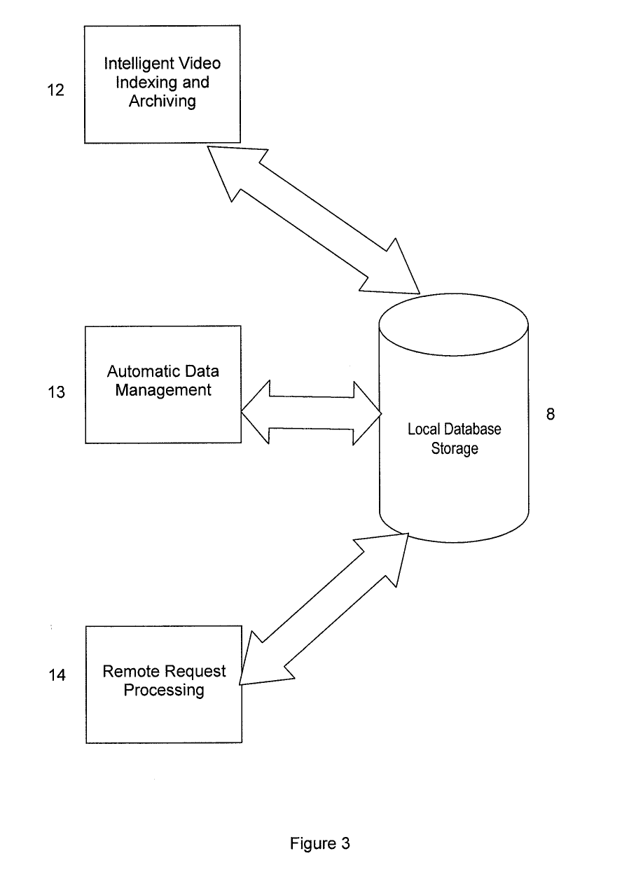

To resolve such problems, an intelligent remote ATM surveillance system is proposed based on the present invention. It will be understood that the present invention may be applied wherever video surveillance is carried out, and that the present example directed towards an ATM is merely for simplification and exemplification. For example, the invention may also be adapted for use in banks or at petrol service stations. FIG. 2 gives an overview of the proposed intelligent remote ATM surveillance system; and FIG. 3 to FIG. 8 describe the detailed operations of the proposed intelligent remote ATM surveillance system.

In FIG. 2, an intelligent remote ATM surveillance system is placed at the remote site where the monitored ATM machine 1 is located. The analog video captured by the camera 2 is digitized, analyzed, indexed, archived, and managed by the intelligent remote ATM surveillance system 6. A remote user can retrieve the video data stored and perform real-time video monitoring from the intelligent remote ATM surveillance system through communication channels such as: PSTN, ISDN, Internet, and Intranet. Note that the video data stored 8 by the intelligent ATM surveillance system 6 includes both video clips 5 and key frames 4. As the people doing the ATM transaction are of real concern, the proposed key frame selection method of clear face is used to extract key frames.

FIG. 3 gives the structure of the proposed intelligent remote ATM surveillance system 6. The intelligent remote ATM surveillance system 6 includes four parts. They are intelligent video indexing & archiving unit 12, automatic data management unit 13, remote request processing unit 14, and local database 8. The intelligent video indexing & archiving unit 12 is responsible for analyzing video information captured by the camera 2, identifying useful video clips 5 (people 7 doing ATM transactions), indexing and archiving the identified information into local database 8. The automatic data management module 13 is responsible for managing the ATM transaction data. It will delete outdated data, generate statistic reports, and send an alarm to operators when there is shortage of storage space. The remote request processing unit 14 will handle all the requests from remote users. If a remote data retrieval request is received, the remote request processing module 14 will find the desired data from local database 8 and pass the data back to the remote user.

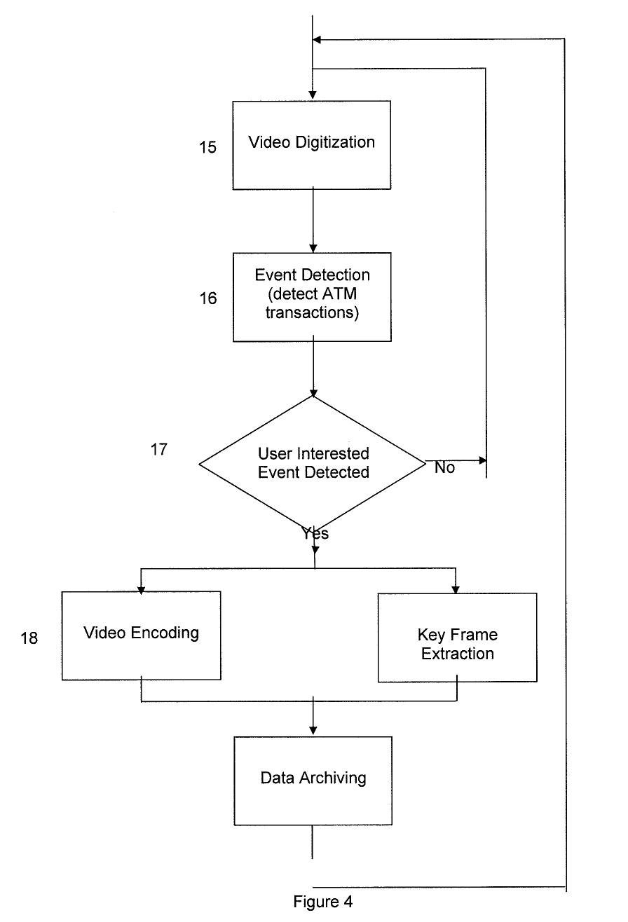

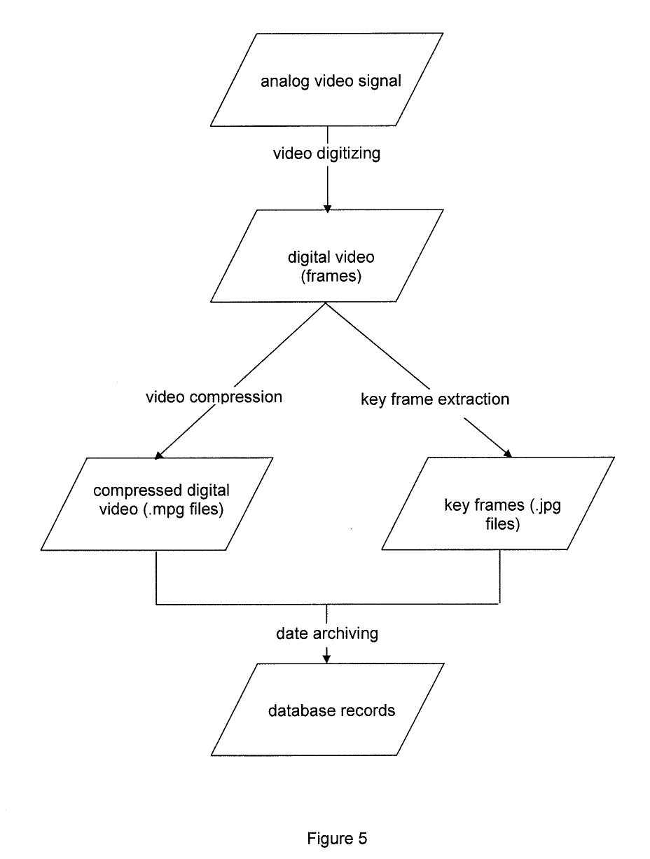

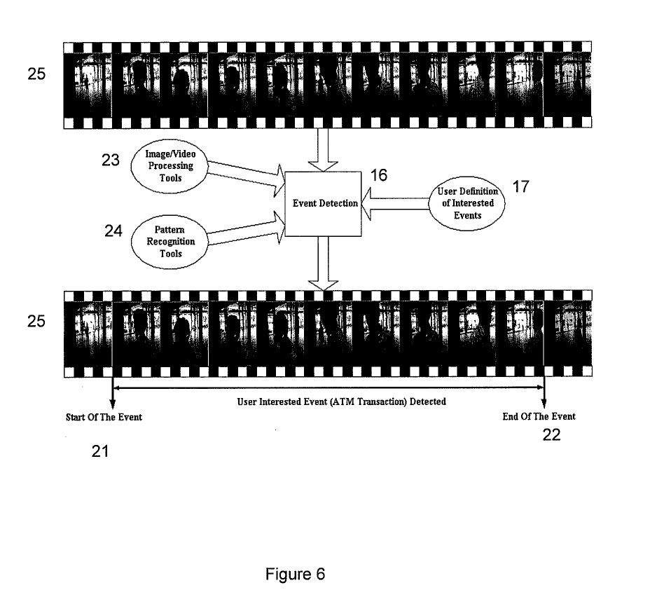

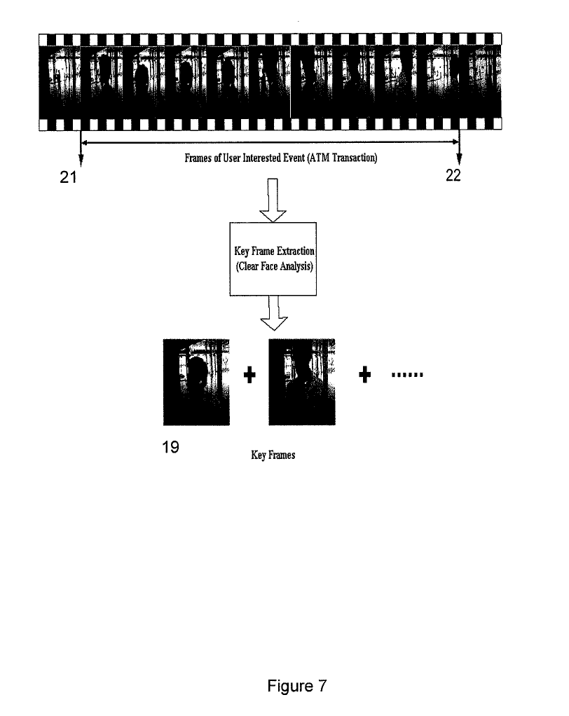

A detailed flow graph of the intelligent video indexing & archiving module is shown in FIG. 4. The analog video signal captured by the camera will be digitized 15 before being passed to the event detection module 16. A set of image/video processing 23 and pattern recognition 24 tools is used in the event detection module 16 to identify the start 21 and end 22 of an ATM transaction, (see FIG. 6). If an ATM transaction is identified, the digitized video will be further processed by the proposed key frame selection method of clear faces to extract a number of key frames 19. In the intelligent remote ATM surveillance system 6, the preferred embodiment of the present invention, the extracted key frames are therefore frames that contain clear frontal faces of the persons doing ATM transactions, (see FIG. 7). In parallel, the digitized video data of the ATM transaction is compressed by the video encoding module 18. Once the event detection module detects the end of an ATM transaction, the compressed video data as well as the extracted key frames will be indexed by time, location, and other information, and archived into local database. The data flow of the above-described process is given in FIG. 5.

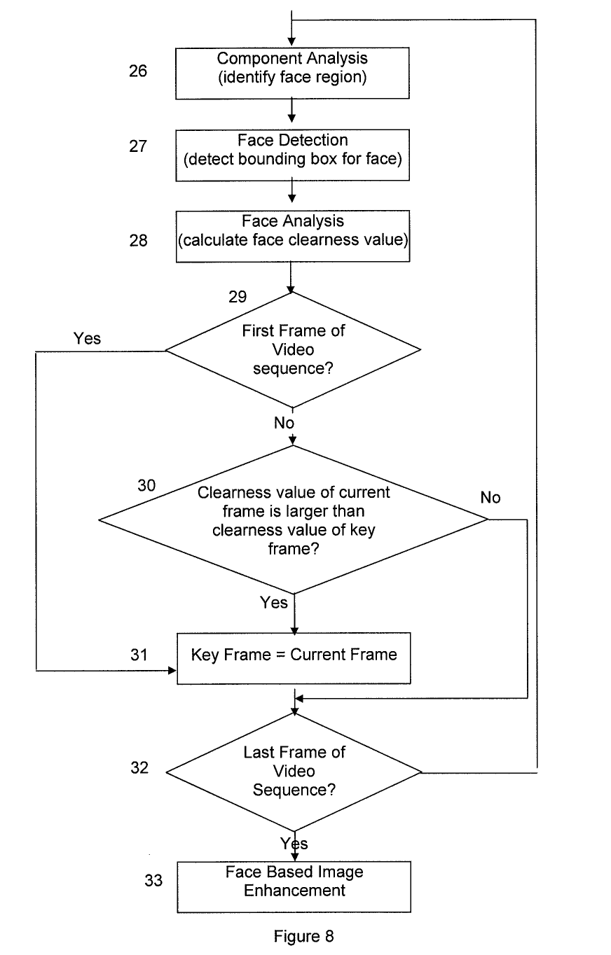

The block diagram of the proposed clear face analysis for key frame extraction is given in FIG. 8. Once an event of interest 17 is detected, each frame of the video clip 25 of the event will be processed by the proposed key frame extraction method. Only the frames with clear faces will be selected as key frames and saved into separate files. From FIG. 8, it can be observed that a component analysis means 26 is first used to analyze the pixels of the frame in the video clip and identify a possible region containing human face.

The component analysis means 26, may operate in two modes to identify the possible face region.

The first mode is suited for uncompressed video data. In this mode, standard image processing techniques are applied to each image frame. Pixels in each image are grouped into regions based on their grey-level or color information. Filtering techniques are used to filter out unwanted regions. If background information (for example, a known background image) is provided, it will be used in the filtering process to discard regions which belong to the background. After filtering, based on some shape information, a region which is most likely to contain a face is identified. The shape information may include head-shoulder shape (for grey-level images) and face shape (for color images).

The second mode is suited for compressed video data. In this mode, video processing techniques are used to analyse compressed video data. Compressed video data contains I frame, B frame, and P frame. For both I frame and P frame, DCT coefficients are analyzed, segmentation and filtering techniques are applied, and the possible face region is identified. For B frame, however, no segmentation is performed. Using motion vector information, the possible face region is estimated from face regions which are identified in related I frame and B frame.

Once the region containing a face is identified, a detection means 27 is used to scan through the region and find the most likely position of a face by identifying a top, bottom and sides of the bounding box of the face. This step can make use of standard pattern recognition techniques such as feature finding (eye, nose, mouth, face contour, skin color, and etc.), neural network and template matching. At present, if compressed data is presented, then it is decompressed before the processing. In some embodiments it may be elected to omit the component analysis means and rely solely on the detection means to identify the face. Such an arrangement will enable the face to be located although in some instances may take longer to process.

A face analysis means 28 is then employed to analyze the pixels of the face region and use a set of tools to determine a numerical value for each face region which indicates the clearness degree of the pixels contained in that face region. The clearness degree of a face region may be defined as a weighted sum of several factors for example:

Clearness Degree=w1×structural completeness+w2×contrast value+w3×symmetry value+w4×whatever user-defined criterion+. . .

The weights (w1, w2, w3, w4, . . . ) can be chosen in such a way that the resultant clearness degree will have a value between 0 and 1. If the clearness degree is 0, it means the face is not clear at all. If the clearness degree is 1, it means the face is perfect. Other ranges may of course be employed.

A human face contains two eyes, one nose and one mouth. All these components are placed in relatively consistent positions. This can be termed the structural information of the face. Standard image processing techniques (segmentation, filtering, morphological operation, and etc.) can be used to find face components from the identified face region. After face components are found, standard pattern recognition techniques (such as template matching, graph matching, and etc.) can be used to analyze whether the found components conform to the face structural information. A value will be given to indicate how good the found components and their relationships are. Value 1 indicates that the found components comprise a perfect face. Value 0 indicates the find face region contains no face.

Contrast values may also be derived. By analyzing the grey-level histogram of the pixels in the identified face region, we can find the range of grey-level values of the pixels in the face region. If the range is from h1 to h2, that is, the lowest grey-level value in the face region is h1 and the highest grey-level value in the face region is h2. The contrast value will be equal to h2−h1.

If multiple face regions are identified in one frame, the highest clearness value of face regions will be taken as the clearness value of the frame. Frames with the highest clearness value will be kept as key frames. After selecting key frames, a region based image enhancement means is then used to enhance the key image based on the grey-level distribution of the identified face region. For example, the grey band may be extended to provide a greater contrast in the image.

FIG. 8 shows the preferred process for determining the frame with the clearest face. The process commences by receiving a video stream by any means. This could include video footage filmed by an ATM following motion detection, or alternatively initiation of a transaction by a user at a ATM. Similarly, the process may be used for video footage received from a source other than a ATM. The video stream is analysed frame by frame. Each frame is firstly analysed 26 to determine a region of the frame within which it is possible for a face to reside. This component analysis 26 may include examining each pixel within the frame to either rule out or determine this possible region.

Once the possible region has been located, the region is then scanned 27, to find the most likely position of the face. This face detection 27 ideally identifies the top, sides and bottom of the person face, and may be determined through object identification, motion analysis, or object edge detection, or any other suitable means. Once the face has been detected 27 within the region 26, the system then analysis the face to determine a clearest value 28.

If the system is examining the first frame 29 of the video stream 25, then this frame becomes the key frame 31. If the current frame is not the first frame 29 of the video sequence 25, then the clearest value of the current frame is compared to that of the current key frame 30. If the clearest value of the current frame suggests an image which is clearer then the existing key frame, then the current frame becomes the key frame 31.

This process repeats 32 until such time as each frame of the video stream 25 has been examined.

Preferably, the key frame 19 selected by the system as having the clearest face image in the video stream 25 will then be processed to improve or enhance the image.

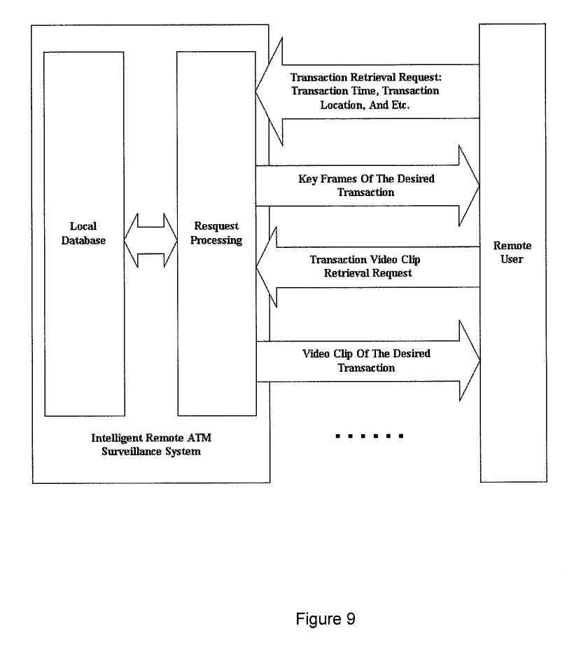

The flow diagram of the remote data retrieval of the proposed intelligent remote ATM surveillance system is given in FIG. 9. Unlike digital video recording systems, a smart two-step remote data retrieval is employed in the proposed intelligent remote ATM surveillance system. Instead of spending days or weeks to find a particular video sequence or event or frame from numerous videotapes, the bank officer can immediately get what they want by simply typing in time, location or transaction information. Once the intelligent remote ATM surveillance system receives the request, it will find the closest records from the local database on the basis of the provided information. Instead of returning the whole records (video plus frames), which may cost several minutes to transmit, the intelligent remote ATM surveillance system first returns the key frames of the found transaction. The transmission of key frames only takes a few seconds. If the bank officer identifies that the returned transaction record is the correct one, the compressed video data of the desired transaction can be returned in a later stage.

In view of the foregoing, it will be seen that the several objects of the invention are achieved and other advantageous results are obtained.

The clear face analysis method introduced by the invention employs a more sophisticated and intelligent way for culling out less-important information and selects frames with higher content importance as indexes for video sequences. In the present invention, a component analysis means is used to analyse the pixels of the frame in a video sequence and identify a possible region containing human face. Once the region containing the face is identified, a detection means is used to scan through the region and find the most likely position of the face by identifying a top, bottom and sides of the bounding box of the face. A face analysis means is then employed to analyze the pixels of the face region and use a set of tools to determine a numerical value for each face region which indicates the clearness degree of the face contained in that face region. If multiple face regions are identified in one frame, the highest clearness value of face regions will be taken as the clearness value of the frame. Frames with the highest clearness value will be kept as key frames. After selecting key frames, a region based image enhancement means is then used to enhance the key image based on the grey-level distribution of the identified face region. The proposed clear face analysis method for key frame extraction will allow one to avoid reviewing each frame in the video sequence. Instead, one need only examine the key frames that contain important face information of the person in the video sequence.

As various changes could be made in the above constructions without departing from the scope of the invention, it is intended that all matter contained in the above description or shown in the accompanying drawings shall be interpreted as illustrative and not in a limiting sense.

1. A system for determining a key frame of an image sequence wherein said key frame includes a clearest image of a face of a person from said image sequence, said system including:
an image input means for receiving the image sequence of the person; and
a processing means for identifying the face of the person in each frame of the image sequence and then determining which frame is the clearest image of the persons face.

2. A system as claimed in claim 1 wherein said processing means analyses each frame of the image sequence including the steps of:
analysing the frame to identify a possible region for the face;
scanning the region to find the most likely position of the face; and
analysing the face to determine a clearest value.

3. A system as claimed in claim 2, wherein said processing means filters out known background information.

4. A system as claimed in claim 2, wherein pattern recognition techniques are utilized to determine the position of the face in said region.

5. A system as claimed in claim 2, wherein the clearest value is defined as a weighted sum of predefined factors.

6. A system as claimed in claim 5, wherein said clearest value is defined as:
Clearest Value=w1×structural completeness+w2×contrast value+w3×symmetry value
wherein w1, w2 and w3 are predefined constants.

7. A system as claimed in claim 6, wherein pattern recognition techniques are utilized to determine whether found components conform to known face structural information, and assigning a value to said structural completeness based on the degree of conformation.

8. A system as claimed in claim 6, wherein the contrast value is derived by subtracting the lowest grey level value in the face region from the highest grey level value in the face region.

9. A system as claimed in claim 2, wherein the clearest value for each frame is compared to determine the clearest frame.

10. A system as claimed in claim 2, wherein the possible region for the face is determined by analysing each of the pixels in the frame.

11. A system as claimed in claim 2, wherein the region is scanned to identify top, bottom and sides of the person's face.

12. A system as claimed in claim 1 further including a storage means for storing said key frames.

13. A system as claimed in claim 12, wherein said video sequence and/or further data is stored together with said key frame.

14. A system as claimed in claim 13, wherein said data includes time, date, and location.

15. A system as claimed in claim 1 further including an image capture means for capturing the image sequence of the person and forwarding said image sequence to said image input means.

16. A system as claimed in claim 15 wherein said image capture means includes a video camera.

17. A system as claimed in claim 1 wherein said key frame is processed by an image enhancement means.

18. An automatic teller machine surveillance system including a system as claimed in claim 1.

19. An automatic teller machines surveillance system as claimed in claim 18 further including a trigger means to initiate surveillance.

20. An automatic teller machine surveillance system as claimed in claim 19 wherein said trigger means is activated by detection of motion.

21. An automatic teller machine surveillance system as claimed in claim 19 wherein said trigger means is activated by said person commencing a transaction at said automatic teller machine.

22. A system as claimed in claim 1 substantially as herein before described with reference to FIGS. 2 to 9 of the accompanying drawings.
